(19) United States
(12) Patent Application Publication
(10) Pub. No.: US 2008/0246312 A1
(43) Pub. Date: Oct. 9, 2008

(54) REAR SECTION STRUCTURE OF VEHICLE

(75) Inventor: Hideaki KATOH, Hino-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: HINO MOTORS, LTD., Hino-shi (JP)

(21) Appl. No.: 12/061,130

(22) Filed: Apr. 2, 2008

(30) Foreign Application Priority Data
Apr. 6, 2007 (JP) 2007-100731

(51) Int. Cl. B62D 27/06; B60J 5/10

(52) U.S. Cl. 296/203.04; 296/29

(57) ABSTRACT

In a rear section structure of a vehicle, corners are defined by upstanding rear pillars at opposite ends of a back door opening and a lower back extending below the back door opening and extending laterally of the vehicle. A lower back inner part is extended to just below a rear pillar outer reinforcement to be joined to a lower portion of the rear pillar outer reinforcement. As a result, the corners can be reinforced without substantially increasing number of parts and assembling man-power.

### TECHNICAL FIELD

The present invention relates to a rear section structure of a vehicle.

### BACKGROUND OF THE INVENTION

Conventionally known is a vehicle with an openable back door on a rear section of a vehicle body. When opened, the back door provides a back door opening on opposite sides of which upstanding rear pillars extend up to a roof of the vehicle body. Arranged below the back door opening is a lower back which extends laterally of the vehicle. Combination of the rear pillars with the lower back provides opposite corners laterally of the vehicle below the back door opening.

FIGS. 1 and 2 show a conventional corner structure defined by the above-mentioned lower back 1 and each rear pillar 2. The lower back 1 comprises lower back outer and inner parts 3 and 4, the inner part 3 with an inward trough being fitted to a back surface of the outer part 4 at an outwardly bulging top bead of the outer part 4, thereby providing a hollow, closed section skeleton structure extending laterally of the vehicle. The rear pillar 2 comprises rear pillar outer and inner reinforcements 5 and 6 which together provide a hollow, upstanding pillar-like, closed section skeleton structure.

Joined to opposite ends of the lower back outer part 3 laterally of the vehicle are side member outer portions 7, which cover side surfaces of the vehicle body, such that the outer portion 7 are turned to the rear surface side of the vehicle body for joining. A lower portion of the rear pillar outer reinforcement 5 is spot welded at A to an upper portion of the lower back outer part 3 through a trough 8 in a three-piled manner. A lower portion of the rear pillar inner reinforcement 6 extending further downward than the rear pillar outer reinforcement 5 is spot welded to the lower back outer part 3 at B just below the bead of the outer part.

Shown in FIG. 1 by imaginary lines for the sake of simplicity and clarification are the lower back outer part 3 which forms an outside of the lower back 1 as well as the side member outer part 7 which covers the side surface of the vehicle body and is turned to the rear surface side of the vehicle body for joint to the lower back outer part 3; the trough 8 and a weld hole 9 shown in FIG. 2 are omitted in FIG. 1.

In FIG. 1, reference numeral 10 denotes a trailer hitch bracket fitted to the lower portion of the lower back outer part 3 as connector for traction of, for example, a camping trailer or a two-wheeled trailer; and 11, the back door opening provided by opening the back door (not shown).

The above-mentioned conventional rear structure of a vehicle has been disclosed, for example, in JP 2003-63450 A.

The conventional structure as mentioned in the above is, however, disadvantageous in that the corners defined by the rear pillars 2 and lower back 1 have deteriorated strength since most of the rear pillar outer and inner reinforcements 5 and 6 constituting each rear pillar 2 are joined only to the lower back outer part 3 at areas laterally outside of the hollow closed section skeleton structure provided by the lower back outer and inner parts 3 and 4.

To overcome this problem, it has been envisaged that the rear pillar outer and inner reinforcements 5 and 6 are connected to the lower back inner part 4 through reinforcing members, which however inevitably results in increase of production cost due to increased number of parts and increased assembling man-hour since the reinforcing members are added as separate parts.

The present invention was made in view of the above and has its object to provide a rear section structure of a vehicle which can reinforce corners defined by rear pillars and a lower back without substantial increase in number of parts and in assembling man-hour.

### SUMMARY OF THE INVENTION

The invention is directed to a rear section structure of a vehicle comprising upstanding rear pillars arranged on opposite sides of a back door opening and a lower back arranged below the back door opening and extending laterally of the vehicle, each of corners defined by said rear pillars and said lower back being reinforced in such a manner that a lower back inner part is extended to just below the rear pillar outer reinforcement to be joined to a lower portion of the rear pillar outer reinforcement.

Thus, such extension of the lower back inner part leads to extension of the hollow closed section skeleton structure composed of the lower back outer and inner parts to just below the rear pillar outer reinforcement as well as joining of the lower back inner part constituting such highly rigid closed section skeleton structure of the lower back to the lower portion of the rear pillar outer reinforcement, thereby providing strong connection of the rear pillars with the lower back.

In the invention, it is preferable that the lower back inner part is extended further to a region where the side member outer part covering the side surface of the vehicle body is turned to the rear surface side of the vehicle body to be joined to the lower back outer part, and the lower back inner part is also joined to the side member outer part. Such joining of the lower back inner part, which has been joined to the lower portion of the rear pillar outer reinforcement, also to the side member outer part further enhances the rigidity.

In the invention, it is preferable that the lower back inner part is also joined to the rear pillar inner reinforcement which extends further downward than the rear pillar outer reinforcement. Such joining of the lower back inner part, which has been joined to the lower portion of the rear pillar outer reinforcement, also to the rear pillar inner reinforcement further enhances the rigidity.

In the invention, it is preferable that the lower back inner part is extended laterally of the vehicle and outwardly of a trailer hitch bracket, which enhances strength of the lower back against traction force applied to the bracket, so that the corner section defined by the rear pillars and the lower back is prevented from being stress-concentrated even if the traction force is greater.

### BRIEF DESCRIPTION OF THE DRAWINGS

FIG. 1 is a schematic view showing a conventional structure;

FIG. 2 is a sectional view looking in a direction of arrows II in FIG. 1;

FIG. 3 is a schematic view showing an embodiment of the invention;

FIG. 4 is a sectional view looking in a direction of arrows IV in FIG. 3; and

FIG. 5 is a sectional view looking in a direction of arrows V in FIG. 3.

### DESCRIPTION OF THE PREFERRED EMBODIMENT

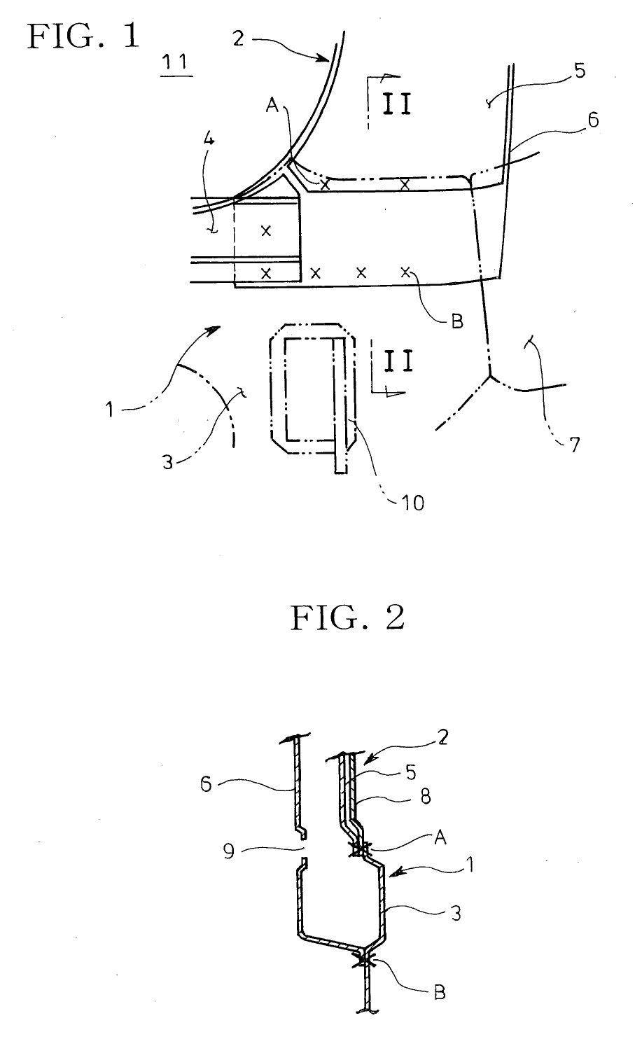

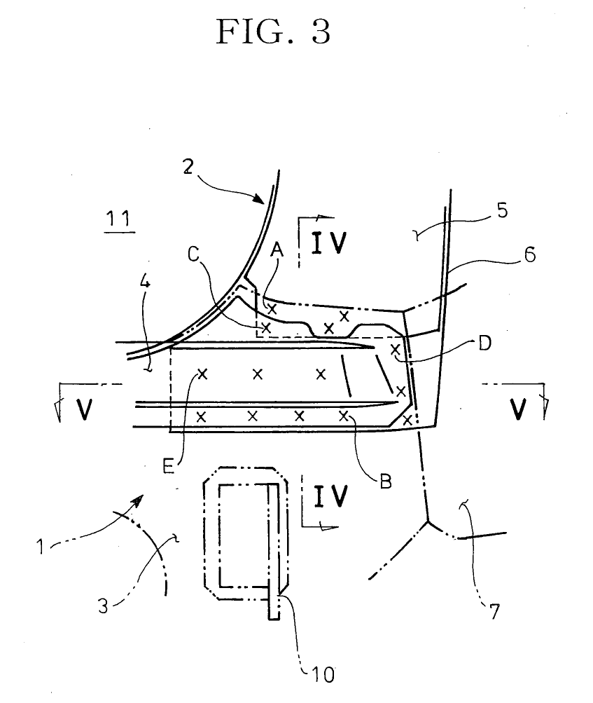

An embodiment of the invention will be described in conjunction with FIGS. 3-5 in which parts similar to those in FIGS. 1 and 2 are represented by the same reference numerals.

As shown in FIGS. 3-5, the embodiment is directed to a rear section structure fundamentally similar to that shown in FIGS. 1 and 2. A lower back inner part 4 is extended to just below a rear pillar outer reinforcement 5 and the extension of the lower back inner part 4 is spot welded to a lower portion of the rear pillar outer reinforcement 5 together with an upper portion of a lower back outer part 3 in a three-piled manner at C; above there, just like a conventional structure, an upper portion of the lower back outer part 3 is spot welded at A to the lower portion of the rear pillar outer reinforcement 5 together with a lower portion of a trough 8 in a three-piled manner.

In the embodiment shown, the lower back inner part 4 is extended further to a region where the side member outer part 7 covering the side surface of the vehicle body is turned to the rear surface side of the vehicle body to be joined to the lower back outer part 3; as best shown in FIG. 5, the lower back inner part 4 is closed at each of its longitudinal ends like pouch and is spot welded at D on junction of the side member outer part 7 with the lower back outer part 3 in a three-piled manner.

The lower portion of the rear pillar inner reinforcement 6 which extends further downward than the rear pillar outer reinforcement 5 is spot welded at B just blow the bead of the lower back outer part 3 just like the conventional structure; in this case, a lower portion of the extension of the lower back inner part 4 is pinched therebetween, and the spot welding is conducted in a three-piled manner.

The trough in the extension of the lower back inner part 4 is formed to abut against the rear pillar inner reinforcement 6; at the abutment, the rear pillar inner reinforcement 6 and the lower back inner part 4 are spot welded together at E in a two-piled manner.

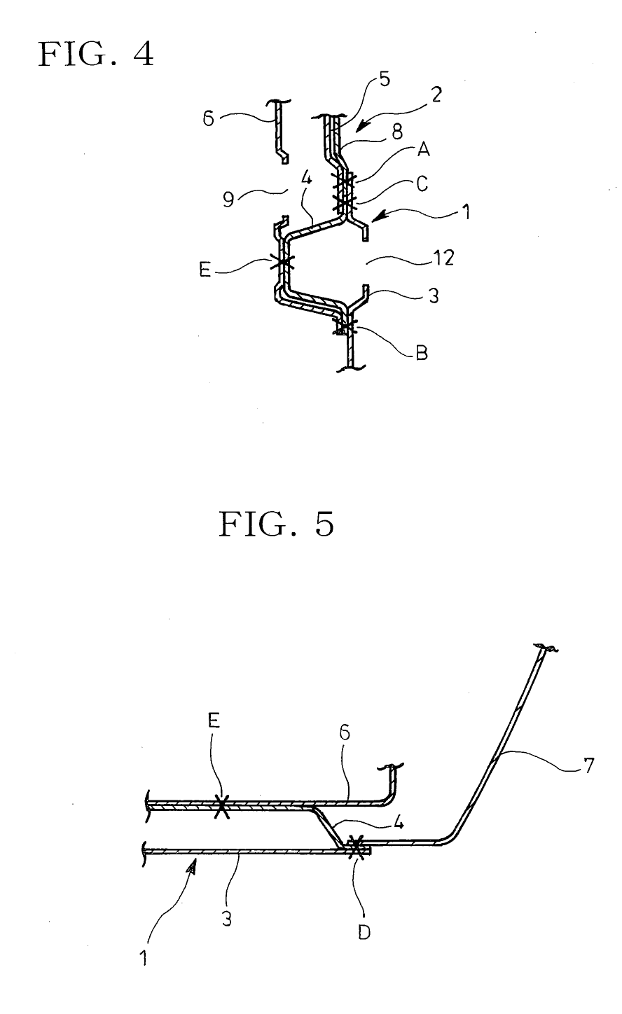

Just like FIG. 1 used for explanation of the conventional structure, shown by imaginary lines for the sake of simplicity and clarification in FIG. 3 used for explanation of the embodiment are the lower back outer part 3 which forms an outside of the lower back 1 as well as the side member outer part 7 which covers the side surface of the vehicle body and is turned to the rear surface side of the vehicle body to be joined to the lower back outer part 3; the trough 8 and the weld holes 9 and 12 shown in FIG. 4 are omitted in FIG. 3.

Thus, in a rear section structure of a vehicle thus constructed, the extension of the lower back inner part 4 leads to extension of the hollow closed section skeleton structure composed of the lower back inner and outer parts 4 and 3 to just below the rear pillar outer reinforcement 5 as well as joining of the lower back inner part 4 constituting such highly rigid closed section skeleton structure of the lower back 1 to the lower portion of the rear pillar outer reinforcement 5 at C, thereby providing strong connection of the rear pillar 2 with the lower back 1.

Especially in the embodiment, the lower back inner part 4 is extended further to a region where the side member outer part 7 covering the side surface of the vehicle body is turned to the rear surface side of the vehicle body to be joined to the lower back outer part 3, and the lower back inner part 4 is also joined to the side member outer part 7 at D. Furthermore, the lower back inner part 4 is also joined at E to the rear pillar inner reinforcement 6 which extends further downward than the rear pillar outer reinforcement 5. Such joining of the lower back inner part 4, which has been joined to the lower portion of the rear pillar outer reinforcement 5, also to the side member outer part 7 and to the rear pillar inner reinforcement 6 further enhances the rigidity.

Thus, according to the above embodiment, without newly adding reinforcing members as separate parts, merely the existing lower back inner part 4 is extended to just below the rear pillar outer reinforcement 5 and is joined to the lower portion of the rear pillar outer reinforcement 5, thereby attaining strong connection of the rear pillar 2 with the lower back 1; moreover, the lower back inner part 4, which has been joined to the lower portion of the rear pillar outer reinforcement 5, is also joined to the side member outer part 7 and to the rear pillar inner reinforcement 6, thereby further enhancing the rigidity. As a result, the corners defined by the rear pillars 2 and the lower back 1 can be reinforced without substantially increasing the number of parts and assembling man-hour, and thus the rigidity of the back door opening 11 surrounded by them can be also substantially enhanced.

In the embodiment shown, the lower back inner part 4 is extended to just below the rear pillar outer reinforcement 5, so that the lower back inner part 4 is extended laterally of the vehicle and outwardly of the trailer hitch bracket 10. Thus, the strength of the lower back 1 is also enhanced against traction force applied to the trailer hitch bracket 10. Even if greater traction force is applied to the trailer hitch bracket 10, the corner defined by the rear pillars 2 and the lower back 1 is prevented from being stress concentrated.

According to a rear section structure of a vehicle of the invention as mentioned in the above, the following various effects and advantages can be obtained.

(I) Without adding reinforcing members as separate parts, merely an existing lower back inner part is extended to just below the rear pillar outer reinforcement and is joined to the lower portion of the rear pillar outer reinforcement, thereby attaining strong connection of the rear pillar with the lower back. As a result, the corners defined by the rear pillars and the lower back can be reinforced without substantially increasing the number of parts and assembling man-hour, and thus rigidity of the back door opening surrounded by them can be also substantially enhanced.
(II) When the lower back inner part is extended further to a region where side member outer part covering the side surface of the vehicle body is turned to the rear surface side of the vehicle body to be joined to the lower back outer part and the lower back inner part is also joined to the side member outer part, such joining of the lower back inner part, which has been joined to the lower portion of rear pillar outer reinforcement, also to the side member outer part can further enhance the rigidity and the corner defined by the rear pillar and the lower back can be further strongly reinforced.
(III) When the lower back inner part is also joined to the rear pillar inner reinforcement extending further downward than the rear pillar outer reinforcement, such joining of the lower back inner part, which has being joined to the lower portion of the rear pillar outer reinforcement, also to the rear pillar inner reinforcement can further enhance the rigidity and the corner defined by the rear pillar and the lower back can be further strongly reinforced.
(IV) When the lower back inner part is extended laterally of the vehicle and outwardly of the trailer hitch bracket, then the strength of the lower back can be enhanced against the traction force applied to the trailer hitch bracket. As a result, even if greater traction force is applied to the trailer hitch bracket, the corner defined by the rear pillar and the lower back can be prevented from being stress concentrated.

It is to be understood that a rear portion structure for a vehicle according to the invention is not limited to the above-mentioned embodiment and that various changes and modifications may be made without leaving the spirit of the invention.

What is claimed is:

1. A rear structure of a vehicle comprising upstanding rear pillars arranged on opposite sides of a back door opening and a lower back arranged below the back door opening and extending laterally of the vehicle, each of corners defined by said rear pillars and said lower back being reinforced in such a manner that a lower back inner part is extended to just below the rear pillar outer reinforcement to be joined to a lower portion of the rear pillar outer reinforcement.

2. A rear section structure of a vehicle as claimed in claim 1, wherein the lower back inner part is extended further to a region where a side member outer part covering a side surface of the vehicle body is turned to the rear surface side of the vehicle body to be joined to the lower back outer part, said lower back inner part being also joined to the side member outer part.

3. A rear section structure of a vehicle as claimed in claim 1, wherein the lower back inner part is also joined to the rear pillar inner reinforcement extending further downward than the rear pillar outer reinforcement.

4. A rear section structure of a vehicle as claimed in claim 2, wherein the lower back inner part is also joined to the rear pillar inner reinforcement extending further downward than the rear pillar outer reinforcement.

5. A rear section structure of a vehicle as claimed in claim 1, wherein the lower back inner part is extended laterally of the vehicle and outwardly of a trailer hitch bracket.

6. A rear section structure of a vehicle as claimed in claim 2, wherein the lower back inner part is extended laterally of the vehicle and outwardly of a trailer hitch bracket.

7. A rear section structure of a vehicle as claimed in claim 3, wherein the lower back inner part is extended laterally of the vehicle and outwardly of a trailer hitch bracket.

8. A rear section structure of a vehicle as claimed in claim 4, wherein the lower back inner part is extended laterally of the vehicle and outwardly of a trailer hitch bracket.
